(19) United States
(12) Patent Application Publication
(10) Pub. No.: US 2010/0146123 A1
(43) Pub. Date: Jun. 10, 2010

(54) RESOURCE ALLOCATION METHOD OF EACH TERMINAL APPARATUS USING RESOURCE MANAGEMENT SYSTEM AND RESOURCE MANAGEMENT SERVER APPARATUS

(75) Inventors: Yunkyung PARK, Daejeon-city (KR); Jeunwoo LEE, Daejeon-city (KR)

Correspondence Address: LADAS & PARRY LLP, 224 SOUTH MICHIGAN AVENUE, SUITE 1600, CHICAGO, IL, 60604, US

(73) Assignee: ELECTRONICS AND TELECOMMUNICATIONS RESEARCH INSTITUTE, Daejeon-city (KR)

(21) Appl. No.: 12/632,021

(22) Filed: Dec. 7, 2009

(30) Foreign Application Priority Data
Dec. 8, 2008 (KR) 10-2008-0124132
Oct. 16, 2009 (KR) 10-2009-0098612

(51) Int. Cl. G06F 15/173

(52) U.S. Cl. 709/226

(57) ABSTRACT

By a method for sharing and using possessed resources between a plurality of terminal apparatuses in a ubiquitous system environment, the resources possessed by the plurality of terminal apparatuses distributed in the system environment are shared and allocated to a user as necessary and the user can combine and use the allocated resources.

### RELATED APPLICATIONS

The present application claims priority to Korean Patent Application Serial Number 10-2008-0124132, filed on Dec. 8, 2008 and Korean Patent Application Serial Number 10-2009-0098612, filed on Oct. 16, 2009, the entirety of which are hereby incorporated by reference.

### BACKGROUND OF THE INVENTION

1. Field of the Invention

The embodiment relates to a ubiquitous system, and more particularly, to a resource allocation method of each terminal apparatus which can allocate resources possessed by a plurality of terminal apparatuses to a necessary terminal apparatus and a resource management server for the same.

2. Description of the Related Art

In general, a ubiquitous computing environment represents an environment which can receive a desired service by accessing a network anytime and anywhere. In order to provide various services in the ubiquitous environment, collaboration between all computing devices in a surrounding area, which provide individual services is an essential condition.

Objects in the ubiquitous computing are connected to an access point (AP) for the Internet through near field communication (NFC) based on short-range wireless communication and use a non-IP based concurrent (real time) short-range wireless communication interface as basic networking. On the basis of the networking, future ubiquitous computing requires a ubiquitous smart space where a computer system can reconfigure a computing environment “anywhere and anytime”.

The ubiquitous smart space locates a plurality of ubiquitous terminal apparatuses within an environment and the terminal apparatuses collaborate with each other to timely and arbitrarily provide a service suitable for a user within the ubiquitous smart space.

However, the known ubiquitous terminal apparatuses have different apparatus environments (for example, device performance). As a result, in case where the user wants to receive the service by using one terminal apparatus, the service can be provided only within the apparatus environment which the terminal apparatus has.

That is, in the known ubiquitous computing environment, since the service is provided to the user by using a terminal environment which each of the terminal apparatuses possesses, the user cannot use a plurality of applications executed in the apparatus environment of the plurality of terminal apparatuses existing within the ubiquitous computing environment.

### SUMMARY OF THE INVENTION

An object of the present invention is to provide a resource allocation method of each terminal apparatus using a resource management system for a user to share and use resources possessed by a plurality of terminal apparatuses.

Another object of the present invention is to provide a resource management server for performing resource allocation between terminal apparatuses.

In order to achieve the above-mentioned object, a resource allocation method of each terminal apparatus according to an aspect of the present invention includes: storing shared resource information received from each of a plurality of terminal apparatuses; extracting, in accordance with a service request from a user, the shared resource information corresponding to the service request among the shared resource information; creating a user virtual machine in accordance with the extracted shared resource information; and allocating the extracted shared resource to the user through the user virtual machine.

In order to achieve another object, a resource management server according to another aspect of the present invention includes: a resource manager that extracts shared resource information corresponding to a user's request for a service among shared resource information transmitted from each of the plurality of terminal apparatuses; and a user virtual machine that is created in accordance with the extracted shared resource information to allocate the extracted shared information to a user.

According to an embodiment of the present invention, a resource allocation method of each terminal apparatus using a resource management system and a resource management server for the same have an advantage in that a user can use various applications without a limitation in a function of the terminal apparatus and can thus implement a more flexible ubiquitous computing environment.

### BRIEF DESCRIPTION OF THE DRAWINGS

The drawings are described in order to more fully appreciate drawings cited in the detailed description of the present invention.

FIG. 1 is a schematic block diagram of a resource management system according to an embodiment of the present;

FIG. 2 is a schematic block diagram of one of a plurality of user terminal apparatuses shown in FIG. 1;

FIG. 3 is a flowchart showing a resource sharing operation of a resource management system according to an embodiment of the present invention;

FIGS. 4 and 5 are flowcharts of an operation of a virtual machine of a shared resource management server shown in FIG. 1; and

FIG. 6 is a diagram showing an operational embodiment of a resource management system shown in FIG. 1.

### DETAILED DESCRIPTION OF THE PREFERRED EMBODIMENTS

The accompanying drawings illustrating embodiments of the present invention and contents described in the accompanying drawings should be referenced in order to fully appreciate operational advantages of the present invention and objects achieved by the embodiments of the present invention.

Hereinafter, the present invention will be described in detail by describing preferred embodiments of the present invention with reference to the accompanying drawings. Like elements refer to like reference numerals shown in the drawings.

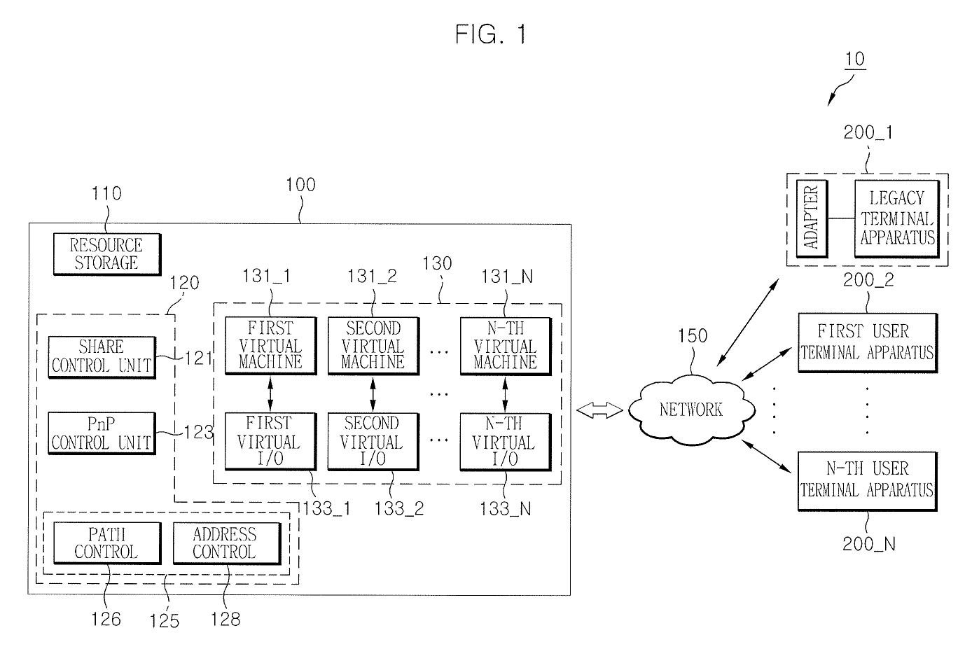

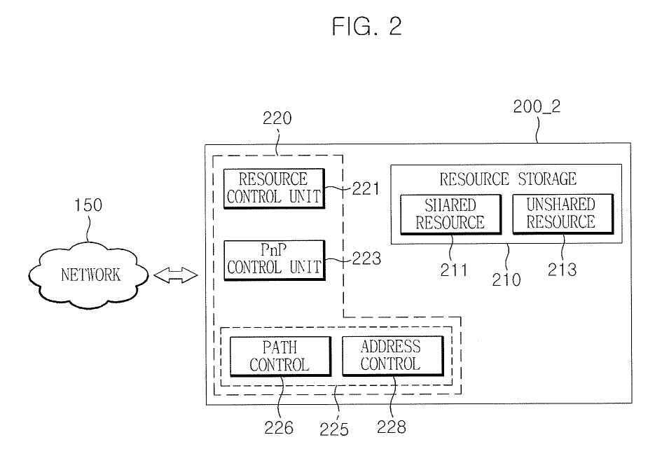

FIG. 1 is a schematic block diagram of a resource management system according to an embodiment of the present invention and FIG. 2 is a schematic block diagram of one of a plurality of user terminal apparatuses shown in FIG. 1.

Referring to FIG. 1, the resource management system 10 according to the embodiment of the present invention may include a shared resource management server 100 and a plurality of user terminal apparatuses 200_1, 200_2, . . . 200_N.

The shared resource management server 100 and the plurality of terminal apparatuses 200_1, 200_2, . . . 200_N can be connected to each other through a network 150. The network 150 may be a wired/wireless network 150 depending on a wired/wireless communication protocol.

The shared resource management server 100 may include a resource storage 110, a resource manger 120, and a user area 130.

The resource storage 110 can store a plurality of shared resource information transmitted from the plurality of user terminal apparatuses 200_1, 200_2, . . . 200_N connected to each other through the network 150.

The resource manager 120 may include a share control unit 121, a plug and play (hereinafter, referred to as ‘PnP’) control unit 123, and a path management unit 125. The path management unit 125 may include a path controlling portion 126 and an address controlling portion 128.

The share control unit 121 can extract one or more necessary shared resource among the plurality of shared resource information stored in the resource storage 110 according to a request for a service from a user.

The share control unit 121 can generate a user virtual machine which can communicate with one terminal apparatus, for example, one terminal apparatus to which the user requests the service among the plurality of terminal apparatuses 200_1, 200_2, . . . 200_N by using one or more extracted shared resource.

Further, the share control unit 121 can compare a request resource amount required to perform the user's request for the service with the amount of the shared resource extracted according to the user's request for service.

The share control unit 121 may provide the extracted shared resource to the user's terminal apparatus, or perform conversion of partitioning or integrating the extracted shared resource according to the comparison result.

For example, if the request resource amount according to the user's request is equal to or more than the amount of the extracted shared resource, the share control unit 121 can generate one user virtual machine by using the extracted shared resource.

One generated user virtual machine can performs the user's request for the service by being allocated the extracted shared resource while communicating with the one terminal apparatus to which the user requests the service.

Further, if the request resource amount according to the user's request is smaller than the extracted shared resource amount, the share control unit 121 can performs conversion of partitioning the extracted shared resource.

Partitioning the extracted shared resource can be performed by the share control unit 121 and can generate one user virtual machine by using the shared resource partitioned according to the performing result.

One generated user virtual machine can perform the user's request for the service by using the partitioned shared resource while communicating with the one terminal apparatus to which the user requests the service.

According to the embodiment, the extracted shared resource may be partitioned by a relevant terminal apparatus among the plurality of user terminal apparatuses 200_1, 200_2, . . . 200_N.

The shared resource partitioned by the terminal apparatus is transmitted to the shared resource management server 100 from the relevant terminal apparatus and stored in the resource storage 110 and the share control unit 121 extracts the stored partitioned shared resource to create the user virtual machine.

For example, the share control unit 121 can request the relevant terminal apparatus which possesses the extracted shared resource to partition the shared resource according to the comparison result.

The relevant terminal apparatus which is requested to partition the shared resource can partition the shared resource which the relevant terminal apparatus possesses.

After the shared resource has bee partitioned, the relevant terminal apparatus can transmit information on the partitioned shared resource to the resource storage 110 of the shared resource management server 100 through the network 150.

The share control unit 121 can extract on partitioned shared resource newly stored in the resource storage 110 and create the user virtual machine by using the same.

Meanwhile, the extracted shares resource can be partitioned as a multiple of a minimum resource partition unit. For example, in case where the amount of the extracted shared resource is 3 and the minimum partition unit is 1 which is a natural number, when the requested resource amount in accordance with the user's request for the service is 1.5, the extracted shared resource can be partitioned into three shared resource each having an amount of 1 according to a minimum partition unit.

As a result, the share control unit 121 can create the user virtual machine by combining two shared resource among three partitioned shared resource and can allocate the partitioned shared resource to the user virtual machine.

The PnP control unit 123 can automatically search the plurality of user terminal apparatuses 200_1, 200_2, . . . 200_N connected to the network 150 and transmit terminal information transmitted from the searched terminal apparatuses, i.e., state information of the terminal apparatus, etc. to the resource storage 110.

According to the embodiment, the resource storage 110 combines the plurality of terminal information transmitted from the PnP control unit 123 with the plurality of shared resource information transmitted from the plurality of user terminal apparatuses 200_1, 200_2, . . . 200_N, respectively to store them.

The path management unit 125 can mange communication paths between a plurality of user virtual machines 131_1, 131_2, . . . 131_N of the user area 130 to be described below and the plurality of user terminal apparatuses 200_1, 200_2, . . . 200_N, respectively.

For example, the share control unit 121 of the shared resource management server 100 can create the plurality of user virtual machines 131_1, 131_2, . . . 131_N that can provide a virtual computer environment to the plurality of user terminal apparatuses 200_1, 200_2, . . . 200_N according to the user's request for the service by using the extracted shared resource.

The plurality of user virtual machines 131_1, 131_2, . . . 131_N can correspond to the plurality of user terminal apparatuses 200_1, 200_2, . . . 200_N, respectively. The share control unit 121 can allocate the extracted shared resource to any one of the plurality of user virtual machines 131_1, 131_2, . . . 131_N.

The path management unit 125 can control the communication path between the user virtual machines and the user terminal apparatuses according to an input/output request in an application executed in the created user virtual machine or an input/output (alternatively, event) request from the user terminal apparatus.

For example, the address control portion 128 of the path management unit 125 can perform address routing so as to process the generated input/output request in the user virtual machine or the user terminal apparatus.

The path control portion 126 of the path management unit 125 can control the communication path between the user virtual machine and the user terminal apparatus so as to process the input/output request in the user virtual machine or the user terminal apparatus according to the address routing.

That is, the path management unit 125 can control the user terminal apparatus to process the input/output request of the user virtual machine and control the user virtual machine to process the input/output request of the user terminal apparatus by generating a virtual interruption in the user virtual machine according to the input/output request of the user terminal apparatus.

The plurality of user virtual machines 131_1, 131_2, . . . 131_N and a plurality of virtual input/output domains 133_1, 133_2, . . . 133_N allocated thereto can be positioned in the user area 130.

The virtual input/output domains 133_1, 133_2, . . . 133_N may be logical domains for a plurality of input/output devices (alternatively, resource) of the plurality of user virtual machines 131_1, 131_2, . . . 131_N, respectively.

Each of the plurality of user virtual machines 131_1, 131_2, . . . 131_N can be created by the share control unit 121 according to the user's request for the service and can provide the virtual computer environment to each of the plurality of user terminal apparatuses 200_1, 200_2, . . . 200_N through each of the plurality of virtual input/output domains 133_1, 133_2, . . . 133_N allocated to the user virtual machines.

The above-mentioned components of the shared resource management server 100, i.e., the resource storage 110, the resource manger 120, and the user area 130 can be connected to each other by an internal bus (not shown).

The plurality of terminal apparatuses 200_1, 200_2, . . . 200_N can be connected to the shared resource management server 100 through the network 150.

The plurality of user terminal apparatuses 200_1, 200_2, . . . 200_N may represent all usable computing resources. The plurality of user terminal apparatuses 200_1, 200_2, . . . 200_N can include electronic apparatuses, i.e., computer devices including a PC, a notebook computer, etc., mobile devices including a PDA, a portable communication device, etc., portable multimedia devices such as a PMP, etc., or display devices such as an IPTV, etc., which can perform network communication.

Referring to FIGS. 1 and 2, the first user terminal apparatus 200_2 can include the resource storage 210 and the user resource manager 220.

Resources possessed by the first user terminal apparatus 200_2 can be stored in the resource storage 210. The resource storage 210 divides the stored possessed resources into a sharable resource 211 and an unsharable unshared resource 213 to store them.

The shared resource 211 is transmitted to the shared resource management sever 100 through the network 150 and represents resource which the plurality of user terminal apparatuses 200_1, 200_2, . . . 200_N share and use. The unshared resource 213 can represent resource used only in the first user terminal apparatus 200_2.

The user resource manager 220 can include a user resource control unit 221, a user PnP control unit 223, and a user path management unit 225.

The user resource control unit 221 can manage the shared resource 211 and the unshared resource 213 that are stored in the resource storage 210 and transmit the shared resource 211 to the shared resource management server 100 through the network 150.

The user resource control unit 221 can transmit the user's request for the service to the shared resource management server 100 and perform the user's request for the service through the user virtual machine of the shared resource management server 100.

The user resource control unit 221 can perform a conversion operation of partitioning or integrating the shared resource 211 stored in the resource storage 210 according to the request of the share resource management server 100. Further, the shared resource converted according to the performing result can be transmitted to the shared resource management server 100.

The user PnP control unit 223 can control the PnP control unit 123 of the shared resource management server 100 to automatically search the first user terminal apparatus 200_2 and may store terminal information of the first user terminal apparatus 200_2 according to the embodiment.

The user path management unit 225 can include the user path control unit 226 and the user address control unit 228 and can manage a communication path between the first user virtual machine 131_1 of the shared resource management server 100 and the first user terminal apparatus 200_2.

For example, the user path management unit 225 can provide the communication path between the first user virtual machine 131_1 and the first user terminal apparatus 200_2 according to an input/output request from an application executed in the first user virtual machine 131_1 or an input/output request from the first user terminal apparatus 200_2.

Meanwhile, one or more user terminal apparatuses among the plurality of user terminal apparatuses 200_1, 200_2, . . . 200_N shown in FIG. 1 may be constituted by an adapter and a legacy terminal apparatus connected thereto.

That is, the adapter performing the operation of the user resource manager 220 is connected to the existing legacy terminal apparatus without the above-mentioned components, i.e., the configuration of the user resource manager 220 and may be configured as the user terminal apparatus according to the present invention.

The configuration of each of the plurality of user terminal apparatuses 200_1, 200_2, . . . 200_N shown in FIG. 1 can be the same as the configuration of the first user terminal apparatus 200_2 shown in FIG. 2.

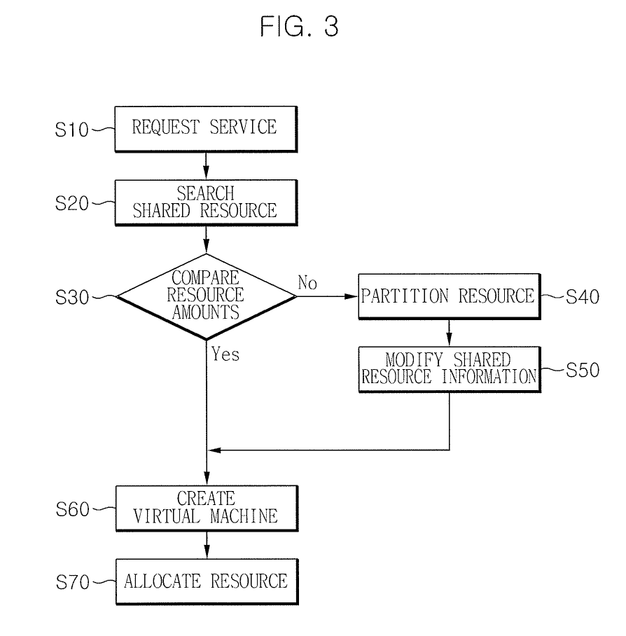

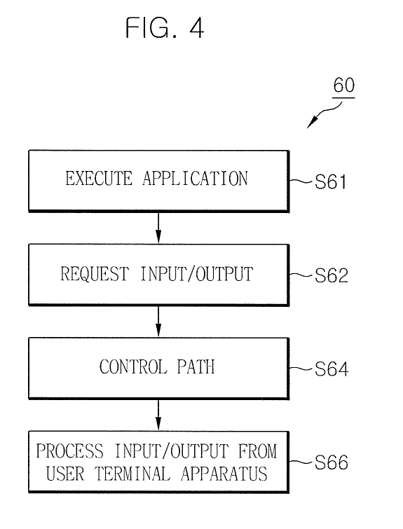

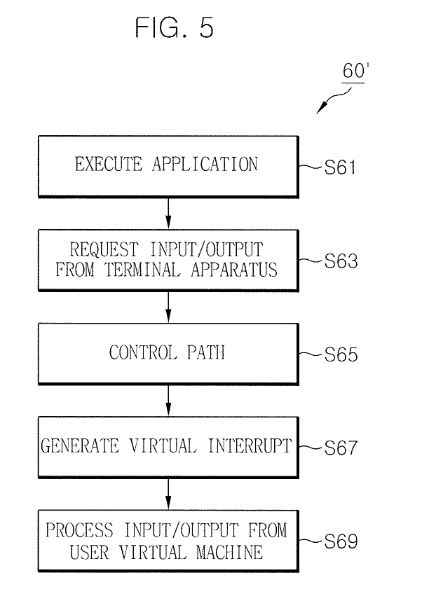

FIG. 3 is a flowchart showing a resource sharing operation of a resource management system according to an embodiment of the present invention and FIGS. 4 and 5 are flowcharts of an operation of a virtual machine of a shared resource management server shown in FIG. 1.

Referring to FIGS. 1 to 3, a user can transmit a request for a service to a shared resource management server 100 through one terminal apparatus among a plurality of user terminal apparatuses 200_1, 200_2, . . . 200_N, i.e., a first user terminal apparatus 200_2 (S10).

The shared resource management server 100 can search and extract shared resource corresponding to a user's request for the service among a plurality of shared resource information stored in a resource storage 110 (S20).

According to an embodiment, the shared resource management server 100, in advance, receives and stores shared resource information from the plurality of user terminal apparatuses 200_1, 200_2, . . . 200_N connected through a network 150 and thereafter, can search and extract the corresponding shared resource according to the user's request for the service.

According to another embodiment, when the shared resource management server 100 receives the user's request for the service, the shared resource management server 100 may search and extract the corresponding shared resource according to the user's request for the service by receiving the shared resource information from the plurality of user terminal apparatuses 200_1, 200_2, . . . 200_N.

The resource manager 120 of the shared resource management server 100 can compare the amount of resources required to perform the user's request for the service and the amount of extracted shared resource with each other (S30).

From the comparison result, if the required resource amount according to the user's request for the service is equal to or larger than the extracted shared resource amount (Yes), the resource manager 120 can create a first user virtual machine 131_1 in order to provide the extracted shared resource to the first user terminal apparatus 200_2 (S60).

However, if the request resource amount according to the user's request is smaller than the extracted shared resource amount (No), the resource manager 120 can perform a conversion operation of partitioning the extracted shared resource (S40).

At this time, the extracted shared resource may be partitioned by the resource manager 120 or by a corresponding terminal apparatus which possesses the extracted shared resource.

When partitioning of the extracted shared resource is completed, the resource manager 120 can modify the shared resource information of the resource storage 110 (S50) and create the first user virtual machine 131_1 in order to provide the partitioned shared resource to the first user terminal apparatus 200_2 (S60).

The shared resource management server 100 can allocate and provide the extracted shared resource or the partitioned shared resource to the user through the first user virtual machine 131_1 while communicating with the first user terminal apparatus 200_2 through the created first user virtual machine 131_1 (S70).

Referring to FIGS. 1, 2, and 4, the shared resource management server 100 can control the first user terminal apparatus 200_2 to process an input/output request (alternatively, event) generated in the first user virtual machine 131_1.

While an application is being executed in the first user virtual machine 131_1 according to the user's request for the service (S61), the input/output request can be generated in the application (S62).

A path management unit 125 of the shared resource management server 100 can control a communication path between the first user virtual machine 131_1 and the first user terminal apparatus 200_2 according to the input/output request of the application (S64).

For example, an address control unit 128 of the path management unit 125 can perform address routing of the first user terminal apparatus 200_2 according to the input/output request generated from the application and a path control portion 126 can control the communication path between the first user virtual machine 131_1 and the first user terminal apparatus 200_2 according to the address routing.

The user can process the input/output request of the application through the first user terminal apparatus 200_2 and transmit the processing result to the first user virtual machine 131_1 (S66).

Referring to FIGS. 1, 2, and 5, the shared resource management server 100 can control the first user virtual machine 131_1 to process an input/output request (alternatively, event) generated in the first user terminal apparatus 200_2.

While the application is being executed in the first user virtual machine 131_1 according to the user's request for the service (S61), the input/output request can be generated from the first user terminal apparatus 200_2 (S63).

The user path management unit 225 of the first user terminal apparatus 200_2 can control the communication path between the first user virtual machine 131_1 and the first user terminal apparatus 200_2 in order to transmit the generated input/output request to the shared resource management server 100 (S65).

The resource manager 120 of the shared resource management server 100 can receive the user's input/output request from the first user terminal apparatus 200_2 and can generate a virtual interruption in the virtual input/output domain of the first virtual machine 131_1 according to the user's input/output request (S67).

The first user virtual machine 131_1 can process the user's input/output request through the application executed according to the generated virtual interruption or another application (S69).

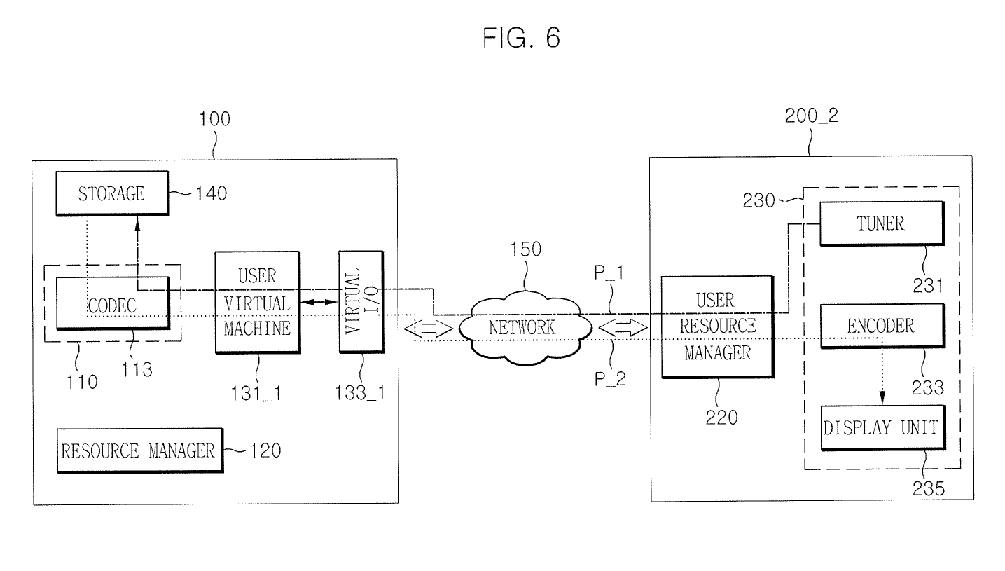

FIG. 6 is a diagram showing an operational embodiment of a resource management system shown in FIG. 1. The embodiment shown in FIG. 6 describes an example in which the user terminal apparatus, that is, the first user terminal apparatus 200_2 is a user's IPTV device and the user performs a personal video recorder (PVR) function for contents of the IPTV device by using the shared resource management server 100.

A PVR as a device that stores AV media data in a mass storage and regenerates the data can record a moving picture without an additional recording medium such as a video tape, a DVD, etc.

Referring to FIG. 6, the shared resource information transmitted from each of the plurality of user terminal apparatuses connected through the network 150, i.e., codec information 113 which can be subjected to media conversion can be stored in the resource storage 110 of the shared resource manager server 100.

Further, the share resource management server 100 may further include a storage which can store massive data as a component.

The first user terminal apparatus 200_2 may include a user resource manager 220 and components 230 of an IPTV device, i.e., a tuner 231, an encoder 233, and a display unit 235.

The user can requests the service to the shared resource management server 100 in order to store media contents watched in the IPTV device, that is, the first user terminal apparatus 200_2.

The resource manager 120 of the shared resource management server 100 can extract corresponding shared resource among the plurality of shared resource information stored in the resource storage 110, that is, the codec information 113 according to the user's request for the service.

The resource manager 120 can create the first user virtual machine 131_1 by using the extracted shared resource and allocate the first input/output domain 133_1 to the first user virtual machine 131_1.

Accordingly, the first user virtual machine 131_1 can communicate with the first user terminal apparatus 200_2 through the first virtual input/output domain 133_1.

The first user virtual machine 131_1 determines the tuner 231 of the first user terminal apparatus 200_2 as a source module, the extracted codec information 113 as a processor module, and the storage 140 as a sync module and can configure a topology such as a first communication path P_1 according to the determination.

The first user virtual machine 131_1 can receive information on media contents which the user wants to store through the network 150 and the first virtual input/output domain 133_1 from the first user terminal apparatus 200_2.

Subsequently, the media contents can be coded by using the extracted shared resource, that is, the codec information 113 and the coded media contents can be stored in the storage 140.

According to another embodiment, the shared resource management server 100 can code the media contents by using the codec information 113 from the first user virtual machine 131_1 and transmit the coded media contents to the first user terminal apparatus 200_2 through the network 150.

According to yet another embodiment, the shared resource management server 100 can code the media contents by using the codec information 113 from the first user virtual machine 131_1 and transmit the coded media contents to the plurality of user terminal apparatuses through the network 150.

Meanwhile, the user can request the service to the shared resource management server 100 in order to display the media contents stored in the storage 140 of the shared resource management server 100 on his/her terminal apparatus, that is, the first user terminal apparatus 200_2.

The resource manager 120 of the shared resource management server 100 can extract corresponding shared resource among the plurality of shared resource information stored in the resource storage 110, that is, the codec information 113 according to the user's request for the service.

The resource manager 120 can create the first user virtual machine 131_1 by using the extracted shared resource and allocate the first input/output domain 133_1 to the first user virtual machine 131_1. Accordingly, the first user virtual machine 131_1 can communicate with the first user terminal apparatus 200_2 through the first virtual input/output domain 133_1.

The first user virtual machine 131_1 determines the storage 140 as the source module, the extracted codec information 113 as the processor module, and the display unit 235 of the first user terminal apparatus 200_2 as the sync module and can configure a topology such as a second communication path P_2 according to the determination.

The first user virtual machine 131_1 can transmit information on media contents which the user wants to display to the first user terminal apparatus 200_2 through the first virtual input/output domain 133_1 and the network 150.

The first user terminal apparatus 200_2 encodes the transmitted media contents information by using the encoder 233 and thereafter, can generate the encoded information from the display unit 235.

That is, the user who owns the IPTV device does not need to additionally purchase apparatuses such as the PVR, etc. in order to store the media contents information of the IPTV and can perform a job to store the media contents by using the shared resource information of the shared resource management server 100 through the above-mentioned first communication path P_1.

Further, the user can regenerate the media contents information by using his/her own IPTV device by using the media contents information stored in the shared resource management server 100 or another user terminal apparatus as the shared resource information through the second communication path P_2.

Although the preferable embodiments of the present invention have been shown and described, it will be appreciated by those skilled in the art that substitutions, modifications and changes may be made in these embodiments without departing from the principles and spirit of the general inventive concept, the scope of which is defined in the appended claims and their equivalents. Accordingly, the actual technical protection scope of the present invention must be determined by the spirit of the appended claims.

What is claimed is:

1. A resource allocation method of each terminal apparatus, comprising:
storing shared resource information received from each of a plurality of terminal apparatuses;
extracting, in accordance with a service request from a user, the shared resource information corresponding to the service request among the shared resource information;
creating a user virtual machine in accordance with the extracted shared resource information; and
allocating the extracted shared resource to the user through the user virtual machine.

2. The resource allocation method of each terminal apparatus according to claim 1, wherein the creating the user virtual machine includes comparing an amount of requested resources required for the service request with an amount of the extracted shared resource included in the extracted shared resource information.

3. The resource allocation method of each terminal apparatus according to claim 2, wherein if the amount of the extracted shared resource is equal to or smaller than the amount of the requested resources, further includes
creating the user virtual machine from the extracted shared resource.

4. The resource allocation method of each terminal apparatus according to claim 2, wherein if the amount of the extracted shared resource is larger than the amount of the requested resources, further includes
partitioning the extracted shared resource; and
creating the user virtual machine from the partitioned shared resource.

5. The resource allocation method of each terminal apparatus according to claim 4, wherein the partitioning the extracted shared resource includes requesting one terminal apparatus which possesses the extracted shared resource among the plurality of terminal apparatuses to partition the shared resource.

6. The resource allocation method of each terminal apparatus according to claim 4, wherein the partitioning the extracted shared resource includes partitioning the extracted shared resource in a multiple of a resource partition unit.

7. The resource allocation method of each terminal apparatus according to claim 1, wherein the allocating the extracted shared resource to the user includes:
executing an application in accordance with the service request by the user virtual machine; and
establishing the communication path between the user virtual machine and the user terminal apparatus in accordance with an input/output request from the user virtual machine or the user terminal apparatus.

8. The resource allocation method of each terminal apparatus according to claim 7, wherein the establishing the communication path includes
establishing the communication path of the input/output request to the user terminal apparatus when the input/output request is generated from the application executed in the user virtual machine.

9. The resource allocation method of each terminal apparatus according to claim 7, wherein the establishing the communication path includes
establishing the communication path of the input/output request as the user virtual machine when the input/output request is generated from the user terminal apparatus.

10. The resource allocation method of each terminal apparatus according to claim 9, wherein the establishing the communication path includes
generating a virtual interruption in the user virtual machine in accordance with the input/output request from the user terminal apparatus.

11. A resource management server connected to a plurality of terminal apparatus through a network, comprising:
a resource manager that extracts shared resource information corresponding to a user's request for a service among shared resource information transmitted from each of the plurality of terminal apparatuses; and
a user virtual machine that is created in accordance with the extracted shared resource information to allocate the extracted shared information to a user.

12. The resource management server according to claim 11, further comprising:
a path manager for establishing a communication path with a use terminal apparatus selected by the user among the plurality of terminal apparatuses.

13. The resource management server according to claim 11, further comprising:
a virtual input/output domain allocated to the user virtual machine.
